(19) United States
(12) Patent Application Publication
(10) Pub. No.: US 2025/0212060 A1
(43) Pub. Date: Jun. 26, 2025

(54) SELECTIVE PAYLOAD COMPRESSION

(71) Applicant: T-MOBILE INNOVATIONS LLC, Overland Park, KS (US)

(72) Inventors: Yu WANG, Fairfax, VA (US); Zheng FANG, McLean, VA (US)

(21) Appl. No.: 18/390,859

(22) Filed: Dec. 20, 2023

(51) Int. Cl. H04W 28/06

(52) U.S. Cl. CPC H04W 28/065

(57) ABSTRACT

Embodiments of the present disclosure relate to an adaptive data management system and methods for telecommunications networks. The system includes a method for receiving data packets and intelligently assigning them to service flows based on content type and network conditions. Different compression protocols are applied to the data packets according to their service flow. The system features a dynamic control unit configured to monitor network conditions and adjust data packet handling in real-time. This includes decompressing and re-compressing data packets to suit the current network environment and user equipment capabilities.

### SUMMARY

The present invention relates to wireless telecommunications with antennas and radio frequency (RF) signal interference.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates an exemplary computing device for use with the present disclosure;

FIG. 2 illustrates a diagram of an exemplary environment in which implementations of the present disclosure may be employed;

FIG. 3 illustrates exemplary environments in which implementations of the present disclosure may be employed;

FIG. 4 illustrates exemplary environments in which implementations of the present disclosure may be employed;

FIG. 5 depicts a flow diagram of an exemplary method, in accordance with embodiments described herein; and

FIG. 6 depicts a flow diagram of an exemplary method, in accordance with embodiments described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like. The term “node” is used to refer to an access point that transmits signals to a UE and receives signals from the UE in order to allow the UE to connect to a broader data or cellular network (including by way of one or more intermediary networks, gateways, or the like)

Embodiments of the technology described herein may be embodied as, among other things, a method, system, or computer-program product. Accordingly, the embodiments may take the form of a hardware-based embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules-in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

The telecommunications industry is rapidly evolving with the advent of 5G technology, which promises unprecedented data speeds, lower latency, and higher capacity compared to its predecessors. This progression necessitates a sophisticated management of data traffic to ensure that the full benefits of 5G are realized. The backbone of this management is an intelligent system capable of handling the complex data flows generated by an array of applications, from high-definition video streaming to real-time gaming and the Internet of Things (IoT) devices.

By way of background, telecommunication networks are the lifeblood of connectivity, enabling a multitude of services from basic internet access to applications like streaming media, real-time gaming, and interconnected internet of things (IoT) devices. As user demand for faster, more reliable, and higher-capacity data transmission grows, the underlying network infrastructures are under increasing pressure to manage the burgeoning data traffic efficiently. The transition to 5G networks has been a significant leap forward, offering the potential to revolutionize data communication with improved bandwidth, reduced latency, and enhanced capacity. However, this transition also brings forth complex challenges in data management, necessitating innovative solutions to optimize network performance while meeting the diverse and escalating requirements of modern communication technologies.

In traditional network systems, as the number of users and the density of networks increase, the technology faces several challenges, particularly in managing data efficiently. One major issue is the high volume of data traffic, which can strain network bandwidth, leading to congestion, especially in densely populated areas or during times of high usage. Additionally, the universal approach to data compression is becoming inadequate. Different types of data react differently to delays and quality loss. For example, a noticeable drop in video quality during a live stream is more problematic than a minor delay in downloading a large file. Another challenge lies in fine-tuning the data compression and decompression processes to be compatible with various User Equipment (UE), each with different capabilities. These challenges highlight the need for a more sophisticated and adaptive data management strategy, one that is tailored to meet the varied demands of modern digital communication.

The methods and systems described herein addresses these challenges head-on by incorporating a multi-tiered compression strategy. This approach differentiates between data packets based on their content type, service flow requirements, and quality of service (QoS) parameters. By utilizing a mixture of compression protocols, the system efficiently compresses data without unnecessary degradation of quality. For time-sensitive data, the system foregoes compression to maintain real-time delivery. Additionally, the system's adaptive nature allows it to adjust compression levels in response to network congestion, ensuring consistent performance even under varying network conditions. By integrating deep packet inspection (DPI) for accurate data classification and instructing UEs on appropriate decompression methods, the system ensures that data integrity is maintained end-to-end. This intelligent management of data not only alleviates network congestion but also enhances user satisfaction by delivering content that meets the high standards expected from modern wireless communication networks.

Accordingly, a first aspect of the present disclosure is directed to a method for adaptive data management in a telecommunications network, optimized for varying data demands and network conditions. This method encompasses receiving diverse types of data packets from a data network, classifying them based on their content type and service requirements, and applying suitable compression protocols. The data packets are then routed through the network, adjusting the compression in real-time to respond to fluctuating network conditions and to maintain quality of service.

Another aspect of the disclosure involves a telecommunications system engineered to enhance data traffic management across 5G networks. The system integrates a policy control function (PCF) for dictating data handling policies and a user plane function

(UPF) for implementing these policies. With multiple service flows each associated with tailored compression protocols, the system dynamically allocates data packets to the appropriate flows. A comprehensive control unit within the system monitors network conditions to adjust these allocations and compression schemes in real-time, optimizing network performance and ensuring seamless data delivery to users despite the ever-present challenge of varying network loads.

An additional aspect comprises a non-transitory computer-readable medium that, when executed by a processor within a network device, performs a method for data packet compression management. The method involves a dual-stage compression protocol, where data packets are initially decompressed if previously compressed by a different protocol, and then re-compressed using a protocol more suited to current network conditions and service flow assignments. The medium includes instructions for both downlink and uplink data handling, with protocols that adjust dynamically to maintain a balance between data throughput, network efficiency, and end-user quality of experience, thereby adapting to the complex demands of modern telecommunications networks.

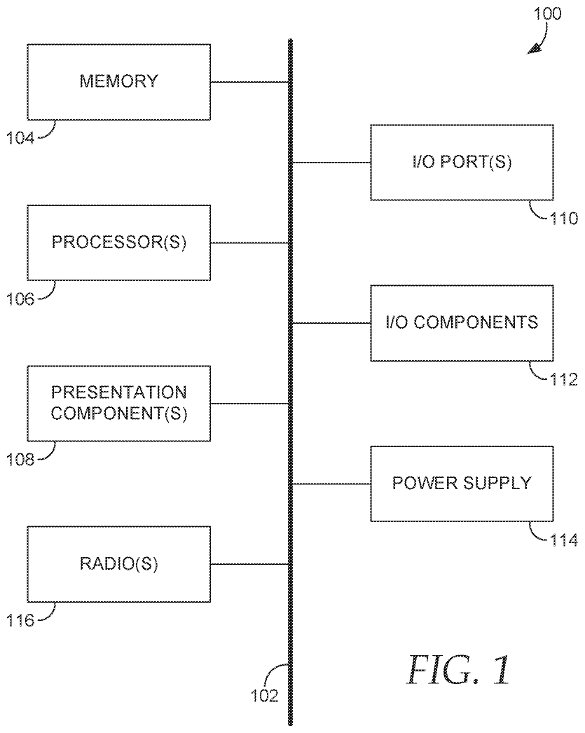

Referring to the drawings in general, and initially to FIG. 1, an exemplary computing environment 100 suitable for practicing embodiments of the present technology is provided. Computing environment 100 is just one example, and is not intended to suggest any limitation as to the scope of use or functionality of the embodiments discussed herein. Furthermore, the computing environment 100 should not be interpreted as having any dependency or requirement relating to any one or a combination of components illustrated. It should be noted that although some components in FIG. 1 are shown in the singular, they may be plural. For example, the computing environment 100 might include multiple processors and/or multiple radios. As shown in FIG. 1, computing environment 100 includes a bus 102 that directly or indirectly couples various components together, including memory 104, processor(s) 106, presentation component(s) 108 (if applicable), radio(s) 116, input/output (I/O) port(s) 110, input/output (I/O) component(s) 112, and power supply 114. More or fewer components are possible and contemplated, including in consolidated or distributed form.

Memory 104 may take the form of memory components described herein. Thus, further elaboration will not be provided here, but it should be noted that memory 104 may include any type of tangible medium that is capable of storing information, such as a database. A database may be any collection of records, data, and/or information. In one embodiment, memory 104 may include a set of embodied computer-executable instructions that, when executed, facilitate various functions or elements disclosed herein. These embodied instructions will variously be referred to as “instructions” or an “application” for short. Processor 106 may actually be multiple processors that receive instructions and process them accordingly. Presentation component 108 may include a display, a speaker, and/or other components that may present information (e.g., a display, a screen, a lamp (LED), a graphical user interface (GUI), and/or even lighted keyboards) through visual, auditory, and/or other tactile cues.

Radio 116 may facilitate communication with a network, and may additionally or alternatively facilitate other types of wireless communications, such as Wi-Fi, WiMAX, LTE, and/or other VoIP communications. In various embodiments, the radio 116 may be configured to support multiple technologies, and/or multiple radios may be configured and utilized to support multiple technologies. The input/output (I/O) ports 110 may take a variety of forms. Exemplary I/O ports may include a USB jack, a stereo jack, an infrared port, a firewire port, other proprietary communications ports, and the like. Input/output (I/O) components 112 may comprise keyboards, microphones, speakers, touchscreens, and/or any other item usable to directly or indirectly input data into the computing environment 100. Power supply 114 may include batteries, fuel cells, and/or any other component that may act as a power source to supply power to the computing environment 100 or to other network components, including through one or more electrical connections or couplings. Power supply 114 may be configured to selectively supply power to different components independently and/or concurrently.

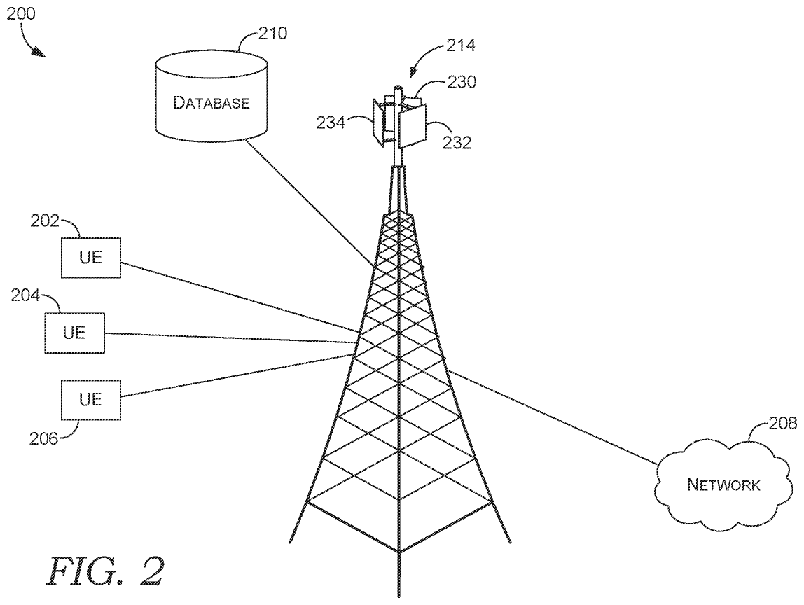

FIG. 2 provides an exemplary network environment in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 includes one or more user devices (e.g., user devices 202, 204, and 206), cell site 214, network 208, database 210, and dynamic mitigation engine 212. In network environment 200, user devices may take on a variety of forms, such as a personal computer (PC), a user device, a smart phone, a smart watch, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, an access point, and any combination of these delineated devices, or any other device that communicates via wireless communications with a cell site 214 in order to interact with a public or private network.

In some aspects, the user devices 202, 204, and 206 correspond to computing device 100 in FIG. 1. Thus, a user device may include, for example, a display(s), a power source(s) (e.g., a battery), a data store(s), a speaker(s), memory, a buffer(s), a radio(s) and the like. In some implementations, the user devices 202, 204, and 206 comprises a wireless or mobile device with which a wireless telecommunication network(s) may be utilized for communication (e.g., voice and/or data communication). In this regard, the user device may be any mobile computing device that communicates by way of a wireless network, for example, a 3G, 4G, 5G, LTE, 6G, CDMA, or any other type of network.

In In other aspects, the user devices 202, 204, and 206 encompass a diverse range of high-throughput and high data consumption devices, catering to various user needs and environments. The first device, 202, corresponds to a Home Internet Network Terminal (HINT). Device 204 represents a Fixed Wireless Access (FWA) device, which provides internet access in areas where wired connectivity is limited or unavailable.

Additionally, device 206 can be any device characterized by high data throughput needs, such as advanced gaming consoles that require rapid data exchange for real-time multiplayer experiences, or professional-grade video conferencing systems used in businesses for high-quality virtual meetings. This category also includes emerging Internet of Things (IoT) devices, like intelligent security cameras and smart home appliances, which constantly transmit and receive data for automation and monitoring purposes. Furthermore, high-performance tablets and laptops, also fall under this category, as they require high-speed internet for cloud computing and large file transfers.

In some cases, the user devices 202, 204, and 206 in network environment 200 may optionally utilize network 208 to communicate with other computing devices (e.g., a mobile device(s), a server(s), a personal computer(s), etc.) through cell site 214. The network 208 may be a telecommunications network(s), or a portion thereof. A telecommunications network might include an array of devices or components (e.g., one or more base stations), some of which are not shown. Those devices or components may form network environments similar to what is shown in FIG. 2, and may also perform methods in accordance with the present disclosure. Components such as terminals, links, and nodes (as well as other components) may provide connectivity in various implementations. Network 208 may include multiple networks, as well as being a network of networks, but is shown in more simple form so as to not obscure other aspects of the present disclosure.

Network 208 may be part of a telecommunication network that connects subscribers to their service provider. In aspects, the service provider may be a telecommunications service provider, an internet service provider, or any other similar service provider that provides at least one of voice telecommunications and data services to any or all of the user devices 202, 204, and 206. For example, network 208 may be associated with a telecommunications provider that provides services (e.g., LTE, 4G, 5G, 6G) to the user devices 202, 204, and 206. Additionally or alternatively, network 208 may provide voice, SMS, and/or data services to user devices or corresponding users that are registered or subscribed to utilize the services provided by a telecommunications provider. Network 208 may comprise any communication network providing voice, SMS, and/or data service(s), using any one or more communication protocols, such as a 1× circuit voice, a 3G network (e.g., CDMA, CDMA2000, WCDMA, GSM, UMTS), a 4G network (WiMAX, LTE, HSDPA), a 5G network, or a 6G network. The network 208 may also be, in whole or in part, or have characteristics of, a self-optimizing network.

In some implementations, cell site 214 is configured to communicate with the user devices 202, 204, and 206 that are located within the geographical area defined by a transmission range and/or receiving range of the radio antennas of cell site 214. The geographical area may be referred to as the “coverage area” of the cell site or simply the “cell,” as used interchangeably hereinafter. Cell site 214 may include one or more base stations, base transmitter stations, radios, antennas, antenna arrays, power amplifiers, transmitters/receivers, digital signal processors, control electronics, GPS equipment, and the like. In particular, cell site 214 may be configured to wirelessly communicate with devices within a defined and limited coverage area. In an exemplary aspect, the cell site 214 comprises a base station that serves at least one sector of the cell associated with the cell site 214, and at least one transmit antenna for propagating a signal from the base station to one or more of the user devices 202, 204, and 206. In other aspects, the cell site 214 may comprise multiple base stations and/or multiple transmit antennas for each of the one or more base stations, any one or more of which may serve at least a portion of the cell. For example, the cell site may comprise a first antenna array 230, a second antenna array 232, and a third antenna array 234, wherein each of the antenna arrays serves a distinct sector (i.e., portion) of the coverage area of the cell 214. In some aspects, the cell site 214 may comprise one or more macro cells (providing wireless coverage for users within a large geographic area) or it may be a small cell (providing wireless coverage for users within a small geographic area).

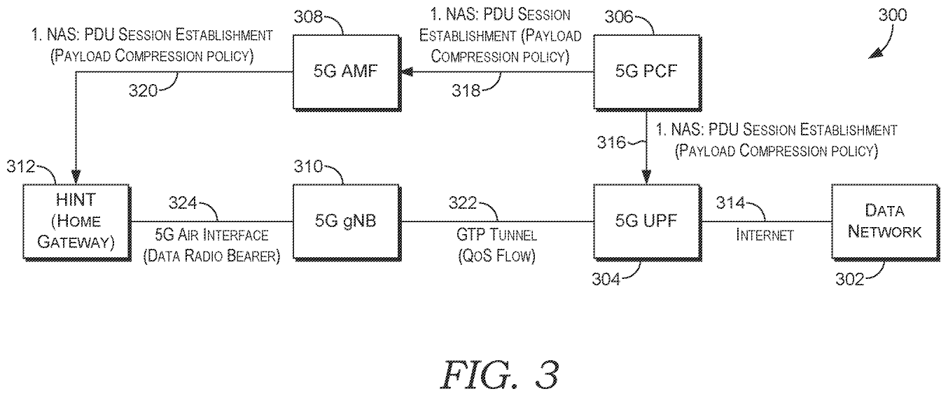

Referring now to FIG. 3, describing an illustrative embodiment of the present disclosure that is depicted. The depiction is centered on system 300, which fundamentally comprises a data network 302, a user plane function (UPF) 304, a policy control function (PCF) 306, an access and mobility function (AMF) 308, a node 310, and a home internet device (HINT device) 312. The data network 302 links components such as UPF 304, PCF 306, AMF 308, node 310, and HINT device 312. This network is designed to facilitate communication and data transfer among these elements, ensuring efficient and reliable network performance. Its role is to provide a platform where each component can effectively communicate and operate, forming a cohesive and dynamic network environment. In this system, the UPF 304 operates to provide data handling. The UPF 304 intelligently manages the incoming data based on the policies provide by the PCF 306. The UPF 304 applies the policies obtained from the PCF 306 and applies compression techniques to efficiently use bandwidth. This is particularly critical for the high-volume data streams generated by HINT device 312. The UPF's 304 algorithms and processing capabilities ensure that data flows smoothly across the network, maintaining high speeds and reducing congestion.

In the system described with respect to FIG. 3, the HINT device 312 is representative of a broader category of high consumption devices that serve critical functions in managing and consuming data traffic. This category encompasses an array of devices such as fixed wireless access points, HINT-specific appliances, or any other high-throughput equipment that demands substantial data processing capabilities. These devices are integral to the telecommunication network's infrastructure, handling large volumes of data and executing complex tasks such as compression and decompression, adhering to the policy rules set by the PCF 306. Their role is not confined to a specific piece of hardware but extends to any device within the network that is characterized by high data consumption and the necessity for data processing power. Whether it is facilitating fixed wireless access in remote areas or managing the hefty data flows in urban centers, these devices are designed to ensure that data is transmitted efficiently and reliably, maintaining the network's high standards of performance and service delivery.

The PCF 306 serves as a central policy authority within the network architecture. It is responsible for creating and managing policy rules that govern network behavior, particularly regarding how data is handled as it traverses the network. When a network operator decides on the specifics of data management, such as compression types and service flow parameters, the PCF 306 operationalizes these decisions. In addition, the policies may designate that they are to be implemented for data packets that are designated to be delivered to HINT device 312 or any other high consumption devices. The policy may specify that if the consumption of the device exceeds a threshold, a particular compression policy is activated based on the service flow and QoS flow 322 of the data packet. The PCF 306 can then translate these policies regarding compression of data into actionable rules that can be understood and enforced by other network functions, such as the UPF 304 or the HINT device 312, or any other high consumption device. Additionally, the PCF 306 maintains a dynamic policy framework that can adapt to the varying needs of network traffic, ensuring that data packets are handled efficiently in accordance with established guidelines.

In practice, the PCF 306 operates by interfacing with various network components to distribute and enforce the compression policies. Once a policy decision is made-such as the implementation of a new traffic payload compression policy—the PCF 306 communicates these rules to the UPF 304 and HINT device 312. The delivery to the HINT device 312 is facilitated by the AMF 308, which acts as a conduit for policy dissemination to the HINT device 312. The AMF 308, which oversees the connectivity and access of user equipment, relays PCF 306 decisions to HINT device 312, which apply the compression and decompression techniques as per the PCF's 306 directives. This is done through PDU session establishment 318 and 320. Additionally, the PCF 306 relays policy decisions directly to the UPF 304 which applies the compression and decompression techniques as per the PCF's 306 directives. Through this coordinated operation, the PCF 306 ensures that the network adheres to the operator's policy decisions, optimizing network resources and user data management.

The policies that govern the data transmitted throughout the network 300 is crafted to define the parameters of data compression in service flows, which are the virtual channels through which data travels in a network. By specifying which service flows are eligible for compression in both downlink and uplink transmissions, the policy provides a targeted approach to data handling. The compression algorithms and levels-ranging from high to low—are selected to match the requirements of different types of data traffic, such as zip, gzip, and deflate.

The UPF 304 is a pivotal component in the network, tasked with the practical application of compression and decompression policies as dictated by the PCF 306. The UPF 304 has responsibilities from the initial classification of incoming data packets to the final stages of data compression and decompression based on the policies received from the PCF 306.

When data enters the network by way of the internet 314 and data network 302, the UPF 304 engages in a complex identification process. Utilizing both packet detection and deep packet inspection (DPI) techniques, it analyzes the metadata and content of each data packet. This scrutiny allows the UPF 304 to determine the nature of the data—whether it is streaming video, voice, or other types of content—and to classify it accordingly. Once identified, the UPF 304 assigns the data to a specific service flow. Service flows are predefined pathways that data packets follow, which are equipped with unique Quality of Service (QOS) characteristics and rules about handling, such as compression requirements.

As part of the UPF's 304 data processing capabilities lies DPI inspects the data payload of each packet, employing complex algorithms to dissect and analyze the content. Through a combination of signature matching, heuristic analysis, and behavioral monitoring, DPI can ascertain the nature of the traffic, determining whether it originates from a video streaming service, a file transfer, or a voice call. This level of analysis is instrumental in identifying the application type and service to which the data belongs, thereby enabling the UPF 304 to assign the packet to the appropriate service flow with its corresponding rules for compression and QoS.

For example, the UPF 304 may determine that the incoming data is from a streaming service, deemed non-time-sensitive. The UPF 304 can also then determine that the data can be compressed to reduce its size. This is because, for such content, a slight delay introduced by the compression and subsequent decompression process will not adversely affect the user experience. The UPF 304 will then apply the appropriate compression algorithm-selected from a range of options like zip, gzip, or deflate-to optimize the data for network transmission.

In contrast, data packets from a time-sensitive service, such as a video conference call, require a different treatment. The UPF 304 recognizes the need for real-time communication in these scenarios and abstains from applying any compression that might introduce latency. The priority is to maintain the integrity and immediacy of the conversation, ensuring that participants experience seamless interaction without noticeable delays.

Beyond the initial compression, the UPF 304 also accomplishes the decompression of data when necessary. If a data packet, previously compressed at an earlier stage in its journey, arrives at the UPF 304, it can be decompressed back to its original form. Additionally, the UPF 304 has the capability to re-compress data at a higher compression level if the policy allows it. This scenario might occur if, during the initial compression, the data was not compressed to its maximum potential due to the service flow's rules or the device's capabilities at the time. The UPF 304 can reassess and apply a more advanced compression method to further reduce the data size, as long as it aligns with the network's current policies and the service's QoS requirements.

In an additional embodiment, the PCF 306 formulates the policy rules which are based on various criteria, including the type of data, the nature of the service flow, and the network's current load and performance metrics. These rules are designed to optimize network traffic by defining which data should be compressed or decompressed, and by what method, to maintain the desired level of service quality.

Once the policies are established at the PCF 306, the PCF 306 communicates them to the HINT device 312. This communication is facilitated by the AMF 308. The AMF 308 acts as an intermediary, taking the policy rules from the PCF 306 and relaying them to the appropriate network elements, in this case, the HINT device 312. The policy rules received by the HINT device 312 contain explicit instructions for how downlink data should be handled. For data designated for decompression, the HINT device 312 use these rules to determine when and how to revert the compressed data to its original state before it is delivered to the end-user. This ensures that the data arrives in a usable form, while also optimizing network efficiency during transmission.

Additionally, the same set of policy rules may also instruct the HINT device 312 to apply compression to uplink data. This involves identifying the service flow to which the uplink data belongs and applying the compression algorithm specified by the PCF 306 delivered policy. This compression is particularly important for data that is not time-sensitive, as it can be reduced in size to conserve bandwidth and improve network performance.

The HINT device 312, having received the policy rules regarding compression from the PCF 306 via the AMF 308, first process the uplink data originating from user equipment. Depending on the instructions embedded within the policy, the HINT device 312 may compress the data in adherence to the service flow it is associated with. Once this initial compression is complete, the HINT device 312 then forward the data to the UPF 304 by way of the node 310 and the air interface 324.

Upon receiving the uplink data, the UPF 304 applies a set of rules that determine the next steps in data processing. These rules, derived from the policies set forth by the PCF 306, dictate whether the UPF 304 should further compress the data for optimal network efficiency, decompress it if required for processing or routing purposes, or even perform a cycle of decompression followed by recompression at a different compression amount. The latter may be necessary if the data needs to be decompressed for a specific processing task or to transit through a particular network segment, only to be recompressed with a more suitable compression algorithm for the remainder of its journey. This level of intricate handling by the UPF 304 ensures that the data is transmitted through the data network 302 in the most efficient manner possible, optimizing the use of network resources while adhering to quality of service parameters.

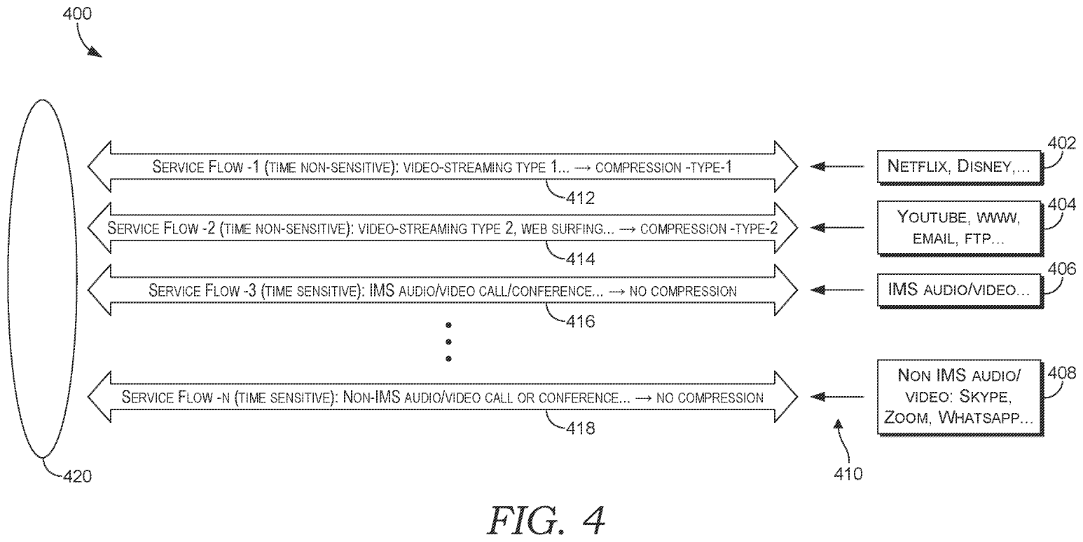

Turning now to FIG. 4, describing an illustrative embodiment of the present disclosure that is depicted. The depiction is centered on system 400, which fundamentally comprises a first data packet 402, second data packet 404, third data packet 406, fifth data packet 408, UPF 410, first service flow 412, second service flow 414, third service flow 416, fourth service flow 418, and a high consumption device 420. In the depicted system 400, the UPF 410 operates as the orchestrator of the compression policies, effectively managing the diverse requirements of various data packets. Each of the data packets and service flows described herein are meant to be exemplary and assigned based on the policies provide by the PCF and a network manager. For example, the first data packet 402, associated with a video streaming service characterized as time non-sensitive, is promptly identified and assigned to the first service flow 412. This service flow, based on the PCF provided policies, is tailored for content where latency is less critical, allowing the UPF 410 to apply a first type of compression that reduces data size without impacting the user experience. Consequently, this enables more efficient data transmission and optimizes network bandwidth usage.

The second data packet 404, which may be related to a general web surfing type of video streaming where the user's quality of experience is also relatively tolerant of minor delays. The second data packet 404 is channeled into the second service flow 414. Here, a second type of compression, possibly differing in algorithm intensity or type from the first, is employed, aligning with the specific tolerances and expectations associated with such data traffic. Meanwhile, the third data packet 406, which is part of a time-sensitive audio or video call, is routed to the third service flow 416 where it bypasses compression entirely. This ensures maximum quality and real-time interaction, prioritizing immediacy and clarity of communication.

Similarly, the fourth data packet 408, identified as non-IMS (IP Multimedia Subsystem) audio/video content that is nevertheless time-sensitive, is assigned to the fourth service flow 418. In this service flow, like the third, compression is eschewed to preserve the real-time element that is crucial for the seamless delivery of such services. Both the third and fourth service flows are indicative of the system's ability to discern and prioritize data packets that would be compromised by any form of latency, thereby ensuring that the integrity of time-sensitive communications is maintained. Through this intricate management, the UPF 410 upholds the fidelity of the network's service delivery, catering to the nuanced needs of each data type while interacting seamlessly with the high consumption device 420, which relies on the efficient handling of these diverse data packets.

Once the UPF 410 assigns the data packets to their respective service flows in system 400, it proceeds with the tailored compression processes for each packet type, adhering to the established compression policies. The first and second data packets (402 and 404), which are associated with video streaming and web surfing respectively, undergo specific compression protocols. For the first data packet in the first service flow 412, a compression algorithm is applied that reduces the data size without significantly impacting the video quality, given its non-time-sensitive nature. Similarly, the second data packet in the second service flow 414 receives a different compression treatment, potentially using an algorithm optimized for web content, which balances quality and efficiency.

For the third and fourth data packets (406 and 408), assigned to the third and fourth service flows (416 and 418) respectively, no compression is applied, preserving the real-time integrity of time-sensitive audio or video calls. These packets are routed directly to the high consumption device 420 without undergoing any alteration in their data size or quality.

Upon arrival at the high consumption device 420, the packets undergo the decompression process, if they were compressed by the UPF. The device uses corresponding decompression algorithms specified by the policy provide by the PCF to revert the first and second data packets back to their original form, ensuring that the content is delivered in a usable state to the end-user. This decompression is crucial for maintaining the quality and integrity of the data, especially for video and web content.

In the case of uplink traffic, where data is transmitted from the high consumption device 420 back to the UPF 410 and then out to the internet, the device also engages in compression. This compression is particularly important for optimizing the uplink data flow, conserving bandwidth, and improving overall network efficiency. The high consumption device 420 assesses each outgoing data packet and applies appropriate compression algorithms based on the type of data and the service flow it belongs to. This might include compressing non-time-sensitive data more aggressively, while leaving time-sensitive data like real-time video or audio calls uncompressed.

Once compressed, these uplink packets are sent back to the UPF 410, which then routes them to their destination over the internet. Throughout this process, the UPF 410 and the high consumption device 420 work in concert, each playing a pivotal role in ensuring data is managed efficiently, maintaining the balance between network performance and service quality.

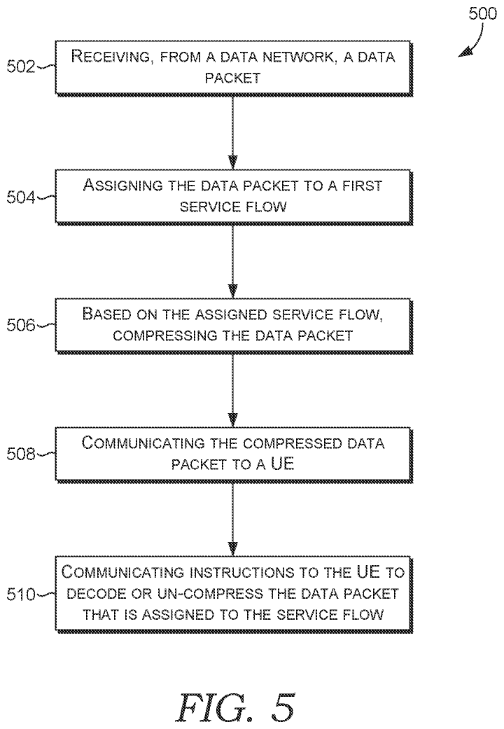

Turning now to FIG. 5, a flow chart representing a method 500 is provided. FIG. 5 presents a detailed flowchart representing the sequence of operations undertaken by the innovative system. Initially, at block 502, the system receives a data packet from a data network. This could be any kind of data, such as a file, a piece of streaming media, or any other data that might be transmitted over a network. At block 504, once the data packet is received, it is assigned to a specific service flow based on the type of data it is. A service flow can be thought of as a type of data stream that has specific QoS parameters assigned to it. These parameters determine how the data should be handled and prioritized as it is processed and transmitted. Such parameters could be a type of compression that is to be applied to the data packet. At block 506, based on the service flow to which the data packet has been assigned, the packet is then compressed according to a compression policy. Compression is the process of encoding information using fewer bits than the original representation. The purpose of compression is to reduce the size of the data packet, which can improve transmission speed and reduce bandwidth usage. At block 508, the compressed data packet is then communicated to the UE, which could be a smartphone, a tablet, or any other device capable of connecting to a data network. Specifically, the UE is a high data consumption device such as a fixed wireless access device. Finally, at block 510 along with the compressed data packet, the system communicates instructions to the UE on how to decode or un-compress the data packet. This ensures that the receiving device knows how to revert the compressed data to its original form.

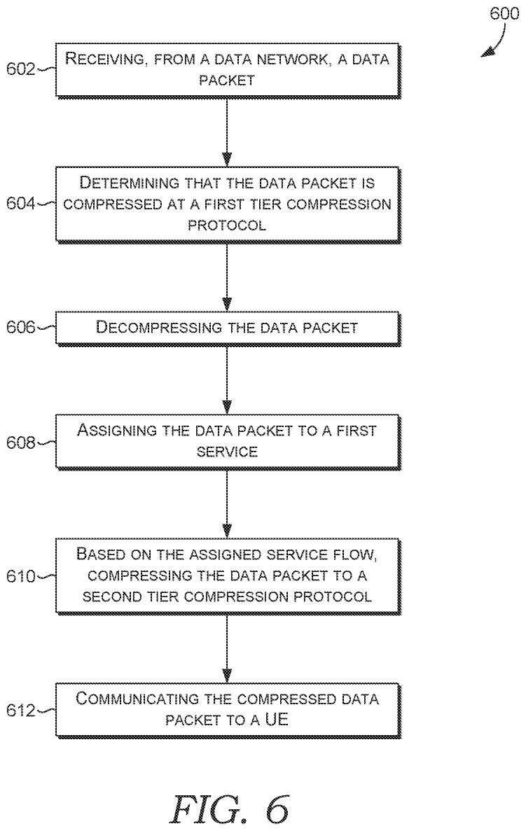

Turning now to FIG. 6, a flow chart representing a method 600 is provided. FIG. 6 presents a detailed flowchart representing the sequence of operations undertaken by the innovative system. Initially, at block 602, the system receives a data packet from a data network. At block 604, after receiving the data packet, the system determines whether the data packet is already compressed using a first tier compression protocol. This implies that there could be multiple levels of compression that the packet has gone through before being received.

As an example, differing tiers of compression are employed to optimize data transmission, each with its own set of protocols tailored to specific types of network traffic. For lower-tier, light compression, protocols such as Real-time Transport Protocol (RTP) Compression are utilized, especially for real-time voice and video calls where minimal latency is paramount. This level ensures swift transmission with slight data reduction. In the medium compression tier, the Lempel-Ziv-Welch (LZW) algorithm is often applied to web traffic, balancing efficiency and quality. It's particularly effective for text, images, and moderate video streaming, offering lossless compression that slightly reduces data size without significantly impacting content integrity. For higher-tier, aggressive compression, protocols like H.264/Advanced Video Coding (AVC) or H.265/High Efficiency Video Coding (HEVC) come into play. These are used for high-definition video content, such as video-on-demand services, where substantial data size reduction is necessary. These protocols manage to significantly compress data while maintaining a high level of video quality, ideal for bandwidth-intensive applications. Each protocol, corresponding to its respective compression tier, plays a critical role in ensuring efficient data management across the network.

The method incorporates a dynamic selection process for the second tier compression protocol, which takes into account real-time network conditions such as load and bandwidth availability. This responsive approach ensures that the network remains efficient and capable of adapting to fluctuating demands. By adjusting the compression protocol in response to the network's current state, the system can maintain optimal performance without compromising data integrity or service quality. Upon the transmission of re-compressed data packets, the UE is configured to adjust its decompression process based on the service flow to which the data packet belongs. This flexibility in the UE's operation allows for tailored decompression, which is especially important when handling different types of data, such as latency-sensitive audio or video calls versus more resilient data types like file downloads.

The UE is designed not only to decompress received data but also to provide feedback on the quality of the decompressed data. This feedback loop enables the network to implement adaptive compression strategies. By analyzing the quality feedback from the UE, the network can refine its compression techniques to better suit the characteristics of the transmitted data, thus enhancing the overall user experience.

At block 606, if the data packet is already compressed, the system will decompress it. This restores the packet to a state before it was initially compressed, potentially to ensure compatibility with the system's processing methods or to re-compress it using a different protocol. At block 608, after assigning the data packet to a service flow, the system compresses the again, this time using a second tier compression protocol. This could be a more efficient compression method, or one that is more suitable for the service flow to which the packet has been assigned. Finally, at block 610, the newly compressed data packet is communicated to the UE which can be a high consumption device such as a fixed wireless access point.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for dynamic data packet compression comprising:
receiving, from a data network, a data packet;
assigning the data packet to a first service flow based on what type of data the data packet is;
compressing the data packet based on the first service flow and a compression policy associated with the first service flow;
communicating the compressed data packet to a user equipment (UE); and
based on the compression policy associated with the first service flow, communicating instructions to the UE to decompress the data packet that is assigned to the first service flow.

2. The method of claim 1, wherein the first service flow is determined based on a content type of the data packet.

3. The method of claim 2, wherein the content type includes at least one of video streaming, audio streaming, or web browsing data.

4. The method of claim 3, further comprising adjusting a compression level based on a current network congestion status.

5. The method of claim 1, wherein the UE is a high consumption device capable of processing high bandwidth data streams.

6. The method of claim 5, wherein the high consumption device is a fixed wireless access point.

7. The method of claim 1, further comprising re-compressing the data packet at the UE for uplink communication based on a second service flow instructions.

8. The method of claim 1, wherein the instructions to the UE include an algorithm for decompression that corresponds to a compression protocol used.

9. One or more non-transient computer-readable media having computer-executable instructions embodied thereon that, when executed, perform a method for dynamic data packet compression, the method comprising:
receiving, from a data network, a data packet;
determining that the data packet is compressed using a first tier compression protocol;
decompressing the data packet; assigning the data packet to a first service flow based a type of data the data packet is;
compressing the data packet using second tier compression protocol based on the first service flow; and
communicating the data packet to a user equipment (UE).

10. The media of claim 9, wherein the first tier compression protocol is a lossless compression protocol.

11. The media of claim 9, wherein the second tier compression protocol is a lossy compression protocol used for multimedia data.

12. The media of claim 9, wherein the determining that the data packet is compressed at a first tier compression protocol comprises using deep packet inspection to identify a compression protocol of the data packet.

13. The media of claim 9, wherein the first service flow is selected based on a quality of service (QOS) requirement associated with the data packet.

14. The media of claim 13, wherein the QoS requirement prioritizes latency-sensitive traffic such as real-time audio or video calls.

15. The media of claim 13, further comprising communicating a request to the UE to provide a confirmation of successful decompression of the data packet.

16. A method for dynamic data packet compression comprising:
receiving a data packet from a data network;
assessing a compression status of the data packet using a first tier compression protocol to determine that the data packet is compressed;
decompressing the data packet;
based on a content type, assigning the data packet to a first service flow of a plurality of service flows;
applying a second tier compression protocol to the data packet, different from the first tier compression protocol, based on the assigned first service flow;
transmitting the re-compressed data packet to a user equipment (UE);
sending decompression instructions corresponding to the second tier compression protocol to the UE; and
instructing the UE to send an acknowledgment upon successful decompression.

17. The method of claim 16, wherein the content type is determined by deep packet inspection techniques to identify data packets as either video, audio, or general web traffic.

18. The method of claim 16, further comprising dynamically selecting the second tier compression protocol based on a current network load and bandwidth availability.

19. The method of claim 16, wherein the UE is configured to adjust a decompression process based on the first service flow of the plurality of service flows to which the data packet is assigned.

20. The method of claim 16, wherein the data packet is associated with a latency-sensitive service flow.
